(19) United States
(12) Patent Application Publication
(10) Pub. No.: US 2020/0063051 A1
(43) Pub. Date: Feb. 27, 2020

(54) PROCESS FOR PRODUCING SYNTHESIS GAS BY GASIFYING SOLID CARBON CARRIERS

(71) Applicant: L'Air Liquide, Societe Anonyme pour I'Etude et l'Exploitation des Procedes Georges Claude, Paris (FR)

(72) Inventors: Matthias MULLER-HAGEDORN, Karlsruhe (DE); Karsten COVELLA, Nidderau (DE); Ingo BAUER, Bad Vilbel (DE)

(73) Assignee: L'Air Liquide, Societe Anonyme pour I'Etude et l'Exploitation des Procedes Georges Claude, Paris (FR)

(21) Appl. No.: 16/488,985

(22) PCT Filed: Feb. 2, 2018
(86) PCT No.: PCT/EP2018/025030

§ 371 Date: Aug. 27, 2019

(30) Foreign Application Priority Data
Feb. 28, 2017 (EP) EP 17400011.7

(51) Int. Cl. C10J 3/08; C10J 3/46; C01B 3/02

(52) U.S. Cl. CPC C10J 3/08; C10J 3/46; C10J 2300/1603; C10J 2300/0916; C10J 2300/0996; C01B 3/02

(57) ABSTRACT

A process for producing synthesis gas by gasifying a carbon carrier in a slurry having a significant content of phosphorus. According to the invention, the phosphorus compounds dissolved in the liquid phase of the suspension are at least partly precipitated by treating the suspension by increasing the pH of the suspension and/or increasing the concentration of metal cations in the suspension, before the suspension is heated further and subsequently applied to the gasification reactor.

### CROSS REFERENCE TO RELATED APPLICATIONS

This application is a § 371 of International PCT Application PCT/EP2018/025030, filed Feb. 2, 2018, which claims the benefit of EP17400011.7, filed Feb. 28, 2017, both of which are herein incorporated by reference in their entireties.

### FIELD OF THE INVENTION

The invention relates to a process for producing synthesis gas by gasifying a carbon carrier having a significant phosphorus content. More particularly, in the process according to the invention, the phosphorus-containing carbon carrier is in solid form as a finely divided powder slurried or suspended in a solvent or dispersant, for example water, water-containing pyrolysis condensate or water-containing pyrolysis oil, and is supplied in this form to the gasification reactor. Alternatively or additionally, the dispersant may also have a significant phosphorus content.

### BACKGROUND OF THE INVENTION

In partial oxidation processes, a carbonaceous feedstock, the carbon carrier, is reacted with an oxygen-containing oxidizing agent in a reaction vessel at high temperatures in order thus to generate a synthesis gas containing hydrogen (H₂) and carbon monoxide (CO). When the carbonaceous feedstock is in solid form, for example as coal or solid biomass, or in liquid form, for example as heavy oil, this is typically referred to as a gasification process, as opposed to reforming of gaseous carbon carriers such as natural gas. In that case, the reaction vessel is referred to as gasification reactor.

The textbook “Gasification”, C. Higman and M. van der Burgt, Gulf Professional Publishing, Elsevier Science (USA) (2003), in chapter 5.3, describes various gasification processes for generating synthesis gas by gasifying solid or liquid carbon carriers. When the carbon carrier is in the form of a powder or dust, reference is also made to entrained flow gasification (ETF) processes. Some of the gasification processes described, for example the Texaco process or the Lurgi-MPG™ process (multipurpose gasification), are also capable of processing slurries of solid carbon carriers in water as dispersant as feedstock to the respective gasification reactor. In this case, a slurry is formed from the finely divided carbon carrier with water and fed to the gasification reactor by means of suitable pumps, and oxygen is applied thereto in cocurrent together with the gasifying agent via one or more burners arranged at the top end of the gasification reactor. It is advantageous here that the water used as dispersant simultaneously also serves as gasifying agent/moderator.

In the processes mentioned, the gasification reactor consists of a reaction chamber having a refractory lining in the upper portion, in which the carbon carrier is reacted with the gasifying agent to give a crude synthesis gas. The reaction chamber is followed, in the lower portion in flow direction, by a cooling zone in which the gas product is abruptly cooled, for example, by passing it through a water immersion and/or by injecting water (called a quench). In addition, the contact with water results in removal of unconverted carbon carrier and of ash/slag particles.

In the case of carbon carriers containing, for example, metals as ash formers or slag formers, the ash is frequently melted in the reaction vessel and leaves the reactor together with the gas phase formed as slag. In combustion technology, slag typically refers to the ash when it has been heated beyond its softening point, such that it is no longer in the fine-particulate or pulverulent state, but becomes dough-like or viscous/fluid.

In the subsequent gas cooling, these streams are cooled down, and so the slag solidifies and can be discharged via lock systems. Processes and apparatuses of this kind are described, for example, in German published specification DE 102007050895 A1. What is important here is that a substantially liquid slag is produced, which can leave the reactor space together with the gas phase. In a specific configuration, this involves mixing a solid feedstock containing carbon and ash formers with a liquid to form a slurry which is pumpable and hence can be fed to the reaction space via a feedstock injector (burner). German published specification DE 10 2005049375 A1 describes a process of this kind. In this case, it is energetically advantageous when the slag is already free-flowing at minimum temperatures. For this purpose, it is possible to add minerals to the feedstock already upstream of the burner, which lower the melting temperature of the ash/slag. In another known process described in US patent specification U.S. Pat. No. 8,771,550 B2, these minerals are added directly to the reaction space.

Especially biomass slurries which have been produced as described in German published specification DE 102005049375 A1 or by a similar process contain significant amounts of K, Ca, Mg, Al, Si and P as ash formers (cf. B. M. Jenkins et al., Fuel Processing Technology 54, 1998, 17-46). In the production of the slurry, a portion of these inorganic compounds goes into solution. This extent depends upon factors including the pH and the temperature of the slurry. Frequently, these biomass slurries have a pH in the acidic range, and so a portion of the phosphates is in the form of hydrogenphosphate or dihydrogenphosphate. The sparingly soluble salts of phosphoric acid with the Ca′ cation are partly in solution under these conditions and show decreasing solubility with temperature. When such a slurry is heated, it has been observed that there is occurrence of precipitates of calcium phosphates, e.g. Ca₃(PO₄)₂, especially in the temperature range from 60 to 180° C., which can lead to blockages of pipelines or burner nozzles, which leads to shutdowns of the gasification plant and to additional maintenance work.

### SUMMARY OF THE INVENTION

Against this background, the problem addressed by certain embodiments of the present invention is that of specifying a process for the production of synthesis gas by gasification of solids-containing carbon carriers in the form of a slurry, which does not have the disadvantages discussed above, i.e. in which, more particularly, the occurrence of blockages of pipelines or burner nozzles in the gasification plant is reliably avoided when solid carbon carriers having a significant phosphorus content are gasified, or when, alternatively or additionally, the dispersant has a significant phosphorus content.

This problem is essentially solved by a process according to certain embodiments of the invention described herein.

### Process According to Certain Embodiments of the Invention

Process for producing a synthesis gas comprising hydrogen and carbon oxides by gasifying a carbon carrier comprising phosphorus and ash formers, especially solid, phosphorus-containing biomass, comprising the following process steps:

(a) providing a suspension (slurry) comprising carbon-containing solids in finely divided form and a liquid dispersant,
(b) treating the suspension by increasing the pH of the suspension and/or increasing the concentration of metal cations in the suspension,
(c) feeding the treated suspension to a gasification reactor and converting the treated suspension in the gasification reactor under gasification conditions with at least one gasifying agent to give a synthesis gas comprising hydrogen and carbon oxides,
(d) discharging the synthesis gas from the gasification reactor and optionally feeding the synthesis gas to further conditioning and/or conversion steps,
(e) discharging a solid or liquid slag from the gasification reactor.

Further advantageous configurations of the process according to the invention can be found in the dependent claims.

Gasification conditions are understood to mean physicochemical conditions which permit at least partial, preferably substantially complete, reaction of the carbon carrier suspended in the slurry with gasifying agents such as oxygen, air and/or water vapour to give synthesis gas constituents. They are known per se from the prior art and, as well as the supply of the gasifying agent(s), also include the establishment of high temperatures. The gasification reaction is often conducted at pressures above atmospheric pressure. The exact gasification conditions will be selected suitably by the person skilled in the art depending on the carbon carrier to be converted.

Carbon carriers are understood to mean all substances or substance mixtures containing carbon in a form convertible to synthesis gas constituents under gasification conditions. Examples here include hard coal, brown coal, biomass and carbonaceous wastes or by-products, for example refinery residues or pyrolysis oils.

The term biomass refers to the body-mass of lifeforms or the parts or body parts thereof. In a wider sense, it is also understood to mean fossil biomass, for example coal, mineral oil or natural gas.

The invention is based on the finding that it is advantageous to precipitate the phosphates dissolved in the dispersant in the slurry to such an extent that no further deposition of solids occurs in the event of a subsequent or downstream process-related temperature increase. Such a process-related temperature increase may occur as a result of the preheating of the slurry in a heat exchanger in order to bring it to the predetermined inlet temperature into the gasification reactor or to lower its viscosity. In order to achieve high heat transfer, the pipe cross sections used in the heat exchanger are of minimum dimensions. This aggravates the problem of blockage resulting from deposition of solid phosphates.

Process-related temperature increases can also occur in other components of the gasification plant which cannot be equipped with adequate heat insulation owing to their small dimensions and which simultaneously have small pipe cross sections. One example here is that of the heat transfer from the reaction chamber of the gasification reactor to the burner nozzle(s), which thus likewise have a tendency to become blocked.

The controlled precipitation of the phosphates according to the invention is possible in various ways that are discussed hereinafter. Which method is employed also depends on the composition of the slurry, and especially whether it has been produced as a water- or organic-based liquid phase.

The controlled precipitation of sparingly soluble phosphates out of the slurry and their presence in the latter does not put the use thereof as feedstock for the gasification reactor at risk, since the solids content additionally generated thereby is small compared to the total solids content in the slurry and changes the essential rheological and other properties of the slurry only to a very minor degree.

One means of performing the process according to the invention involves raising the pH to a sufficiently basic level that the phosphate in solution is present largely as orthophosphate and forms compounds that are sparingly soluble with the cations present to a sufficient degree in solution, for example phosphates of Ca, Mg, Al. Useful substances for increasing the pH include alkalis or else basic salts, for example Na₂CO₃. It is advantageous here when the basic salt used has an anion that is not extraneous to the process, but is as far as possible likewise converted to synthesis gas constituents in the gasification. This is the case, for example, for Na₂CO₃, since the carbonate is converted to carbon oxides in the gasification reactor.

Another means of precipitating the dissolved phosphate ions is that of significantly increasing the level of cations in the solution that cause the substantial precipitation of the phosphate ions as sparingly soluble phosphates. Possible compounds here would, for example, be metal cations such as salts of Ca, Al or Fe. Useful inexpensive admixtures are accordingly quicklime or wastes from the iron or aluminium industry (for example red mud). With regard to the selection of suitable salts/anions, the statements made above should be noted, to the effect that anions extraneous to the process should be avoided as far as possible.

In some cases, it is also possible or necessary to combine these two options. In the choice of these admixtures, it should also be ensured that the addition thereof does not alter the melting point of the ash/slag or alters it only in the desired direction. If the slag, for example in the case of an entrained flow gasification, is to be drawn off from the reaction vessel in liquid form, suitable admixtures are especially those that lower the melting point of the ash. These would be, for example, Na₂CO₃ to increase the pH or Fe salts to precipitate sparingly soluble Fe phosphates. In the case that ash/slag is drawn off in dry form, by contrast, salts of Ca and Al would be a more useful option.

### DETAILED DESCRIPTION OF THE INVENTION

A preferred configuration of the process according to the invention is characterized in that in process step (c) the pH is increased to values of at least 7, preferably at least 9, most preferably at least 10. In principle, the ease with which the phosphates are precipitated, for example as sparingly soluble calcium phosphates, increases with the pH.

It has been found to be particularly advantageous when, in process step (c), the concentration of metal cations in the suspension is increased by adding salts which are at least partly soluble in the dispersant and contain at least one cation selected from the group comprising Ca, Al, Fe. All these metal cations form sparingly soluble phosphates. If necessary, the solubility of the respective phosphate can be minimized further by additional adjustment of the pH.

In a preferred manner, the inventive treatment of the slurry in process step (c) is effected at room temperature or at the production or storage temperature of the slurry. It is preferably effected before the temperature of the slurry is increased further, for example prior to addition of the slurry to the gasification reactor.

It is particularly preferable when an aqueous dispersant is used, for example water, water-containing pyrolysis condensate or water-containing pyrolysis oil. The water content facilitates the production of the slurry and the precipitation of the phosphorus component in insoluble form, and can also serve as a moderator or gasifying agent in the gasification reactor.

It has been found to be particularly advantageous when, in the process of the invention, the treated suspension, before being fed to the gasification reactor, is preheated to a temperature of at least 20° C., preferably at least 60° C., most preferably at least 120° C. Since the gasification is usually conducted at pressures well above atmospheric pressure, the evaporation of water, for example, out of the slurry is substantially avoided at the temperatures mentioned and, at the same time, the solubility of the phosphates is reduced.

In a particular configuration of the process according to the invention, in process step (c) the pH of the suspension is increased by adding Na₂CO₃ and/or a salt which is at least partly soluble in the dispersant and contains Fe is added to the suspension. This lowers the melting point of the ash/slag, and allows the slag to be reliably discharged from the gasification reactor in liquid form.

In an alternative configuration of the process according to the invention, in process step (c) a salt which is at least partly soluble in the dispersant and contains at least one cation selected from the group comprising Ca and Al is added to the suspension. This measure increases the melting point of the ash/slag, and allows the slag to be reliably discharged from the gasification reactor in solid form by means of suitable discharge devices.

In a preferred configuration of the process according to the invention, the solid phosphate precipitates formed in the treatment of the suspension in process step (c) are fed to the gasification reactor together with the suspension. This dispenses with the complex separation of the phosphate particles from the carbon carrier. The presence of the precipitated phosphates in the slurry does not put its use as feedstock for the gasification reactor at risk, since the solids content additionally generated thereby is small compared to the total solids content in the slurry and this alters the essential rheological and other properties of the slurry only to a very minor degree.

In a further preferred configuration of the process according to the invention, in a continuous process regime, the treatment of the suspension in process step (c) in a vessel is effected in such a way that the hydrodynamic residence time T is at least 2 min, preferably at least 5 min, most preferably at least 10 min, the suspension being maintained in the vessel during the residence time by mixing, preferably by stirring. Experience shows that, when these residence times are used, reliable precipitation of the phosphates dissolved in the liquid phase of the slurry is possible.

The process according to the invention can also be conducted batchwise. For this purpose, batches of the slurry are treated by increasing the pH of the suspension and/or increasing the concentration of metal cations in the suspension and subsequently used as gasification feed.

It is particularly favourable when the phosphorus present in the carbon carrier is at least partly in the form of phosphorus compounds that are at least partly soluble in the dispersant. The greater the solubility of the phosphorus compounds in the dispersant, preferably water, the greater that proportion of phosphorus which can be removed in accordance with the invention prior to the introduction into the gasification reactor.

### Working Example and Numerical Example

Further features, advantages and possible uses of the invention will also be apparent from the description of a working example and numerical example which follows. All the features described alone or in any combination form the subject-matter of the invention, irrespective of their combination in the claims or their dependency references.

### Example

A simplified example is used to represent the procedure according to the notice of invention. For better comprehension, an example highly abstracted in the manner of a model for the two inventive configurations of the process step according to claim 1. (c) is presented. The starting basis considered was merely the liquid phase of an aqueous slurry containing water-dissolved calcium phosphate in the slightly acidic range. What is considered subsequently is the aqueous system containing 1000 g of water with 5 g of calcium phosphate and further calcium ions in the form of 1 g of CaCl₂) and a proton source in the form of 0.1 g of HCl.

Thermodynamic calculations with the calculation program FactSage™ showed that, in the course of heating—as also observed in the real case—free phosphate ions are still present in the solution, which precipitate as hydroxylapatite Ca₅(PO₄)₃(OH) with free calcium ions when the temperature is increased (Table 1, comparative example).

In order to prevent this precipitation when the temperature is increased, in accordance with the invention, the pH was raised by addition of 0.55 g of NaOH. As a result, the phosphate was already virtually completely precipitated at room temperature, and no further precipitation of hydroxylapatite occurred with rising temperature (Table 2, invention).

In an alternative configuration, quicklime (calcium oxide, CaO) was added. Table 3 shows the effect of addition of 0.38 g of CaO. Here too, no further precipitation of hydroxylapatite occurred with rising temperature (Table 3, invention).

### INDUSTRIAL APPLICABILITY

The invention provides an improved gasification process with which it is also possible to utilize slurries produced from phosphorus-containing carbon carriers, especially from corresponding biomass, as feedstocks for the production of synthesis gas. In the gasification process improved in accordance with the invention, there is less frequent occurrence of interruptions to operation that are caused by blockages of conduits, apparatuses and nozzles. The availability of the gasification plant for production operation is increased and hence the economic viability of the gasification process is improved.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

TABLE 1
Precipitated amounts of hydroxylapatite and pH values as a function of
temperature for the system 1000 g H₂O + 5 g Ca₃(PO₄)₂ +
0.1 g HCl + 1 g CaCl₂

| p | T | Hydroxylapatite (s) | |
|---|---|---|---|
| (bar) | (C.) | (g) | pH |
| 40 | 20 | 4.47 | 3.45 |
| 40 | 30 | 4.49 | 3.34 |
| 40 | 40 | 4.50 | 3.25 |
| 40 | 50 | 4.52 | 3.15 |
| 40 | 60 | 4.55 | 3.07 |
| 40 | 70 | 4.57 | 2.99 |
| 40 | 80 | 4.60 | 2.91 |
| 40 | 90 | 4.63 | 2.84 |
| 40 | 100 | 4.66 | 2.78 |
| 40 | 110 | 4.68 | 2.71 |
| 40 | 120 | 4.71 | 2.66 |
| 40 | 130 | 4.74 | 2.60 |
| 40 | 140 | 4.77 | 2.55 |
| 40 | 150 | 4.80 | 2.51 |
| 40 | 160 | 4.83 | 2.46 |
| 40 | 170 | 4.86 | 2.42 |
| 40 | 180 | 4.88 | 2.38 |
| 40 | 190 | 4.91 | 2.35 |
| 40 | 200 | 4.93 | 2.32 |
| 40 | 210 | 4.94 | 2.31 |
| 40 | 220 | 4.95 | 2.29 |
| 40 | 230 | 4.96 | 2.29 |
| 40 | 240 | 4.96 | 2.29 |
| 40 | 250 | 4.96 | 2.29 |

TABLE 2
Precipitated amounts of hydroxylapatite and pH values as a function of
the temperature for the system 1000 g H₂O + 5 g Ca₃(PO₄)₂ +
0.1 g HCl + 1 g CaCl₂, addition of 0.55 g NaOH

| p | T | Hydroxylapatite (s) | |
|---|---|---|---|
| (bar) | (C.) | (g) | pH |
| 40 | 20 | 5.40 | 10.59 |
| 40 | 30 | 5.40 | 10.26 |
| 40 | 40 | 5.40 | 9.97 |
| 40 | 50 | 5.40 | 9.70 |
| 40 | 60 | 5.40 | 9.46 |
| 40 | 70 | 5.40 | 9.23 |
| 40 | 80 | 5.40 | 9.03 |
| 40 | 90 | 5.40 | 8.85 |
| 40 | 100 | 5.40 | 8.69 |
| 40 | 110 | 5.40 | 8.54 |
| 40 | 120 | 5.40 | 8.40 |
| 40 | 130 | 5.40 | 8.28 |
| 40 | 140 | 5.40 | 8.17 |
| 40 | 150 | 5.40 | 8.07 |
| 40 | 160 | 5.40 | 7.98 |
| 40 | 170 | 5.40 | 7.91 |
| 40 | 180 | 5.40 | 7.84 |
| 40 | 190 | 5.40 | 7.78 |
| 40 | 200 | 5.40 | 7.72 |
| 40 | 210 | 5.40 | 7.68 |
| 40 | 220 | 5.40 | 7.64 |
| 40 | 230 | 5.40 | 7.61 |
| 40 | 240 | 5.40 | 7.59 |
| 40 | 250 | 5.40 | 7.57 |

TABLE 3
Precipitated amounts of hydroxylapatite and pH values as a function of
the temperature for the system 1000 g H₂O + 5 g Ca₃(PO₄)₂ +
0.1 g HCl + 1 g CaCl₂, addition of 0.38 g CaO

| p | T | Hydroxylapatite (s) | |
|---|---|---|---|
| (bar) | (C.) | (g) | pH |
| 40 | 20 | 5.40 | 9.98 |
| 40 | 30 | 5.40 | 9.65 |
| 40 | 40 | 5.40 | 9.35 |
| 40 | 50 | 5.40 | 9.08 |
| 40 | 60 | 5.40 | 8.84 |
| 40 | 70 | 5.40 | 8.62 |
| 40 | 80 | 5.40 | 8.42 |
| 40 | 90 | 5.40 | 8.24 |
| 40 | 100 | 5.40 | 8.07 |
| 40 | 110 | 5.40 | 7.92 |
| 40 | 120 | 5.40 | 7.79 |
| 40 | 130 | 5.40 | 7.67 |
| 40 | 140 | 5.40 | 7.56 |
| 40 | 150 | 5.40 | 7.46 |
| 40 | 160 | 5.40 | 7.37 |
| 40 | 170 | 5.40 | 7.29 |
| 40 | 180 | 5.40 | 7.22 |
| 40 | 190 | 5.40 | 7.16 |
| 40 | 200 | 5.40 | 7.11 |
| 40 | 210 | 5.40 | 7.06 |
| 40 | 220 | 5.40 | 7.03 |
| 40 | 230 | 5.40 | 7.00 |
| 40 | 240 | 5.40 | 6.97 |
| 40 | 250 | 5.40 | 6.95 |

1-10. (canceled)

11. A process for producing a synthesis gas comprising hydrogen and carbon oxides by gasifying a carbon carrier comprising phosphorus and ash formers, especially solid, phosphorus-containing biomass, comprising the following process steps:
(a) providing a suspension (slurry) comprising carbon-containing solids in finely divided form and a liquid dispersant;
(b) treating the suspension by increasing the pH of the suspension and/or increasing the concentration of metal cations in the suspension;
(c) feeding the treated suspension to a gasification reactor and converting the treated suspension in the gasification reactor under gasification conditions with at least one gasifying agent to give a synthesis gas comprising hydrogen and carbon oxides;
(d) discharging the synthesis gas from the gasification reactor and optionally feeding the synthesis gas to further conditioning and/or conversion steps; and
(e) discharging a solid or liquid slag from the gasification reactor.

12. The process according to claim 11, wherein in process step (c) the pH is increased to values of at least 7.

13. The process according to claim 11, wherein in process step (c) the pH is increased to values of at least 9.

14. The process according to claim 11, wherein in process step (c) the pH is increased to values of at least 10.

15. The process according to claim 11, wherein in process step (c) the concentration of metal cations in the suspension is increased by adding salts which are at least partly soluble in the dispersant and contain at least one cation selected from the group comprising Ca, Al, Fe.

16. The process according to claim 11, wherein the dispersant contains water.

17. The process according to claim 11, wherein the treated suspension, before being fed to the gasification reactor, is preheated to a temperature of at least 20° C., preferably at least 60° C., most preferably at least 120° C.

18. The process according to claim 11, wherein in process step (c) the pH of the suspension is increased by adding Na₂CO₃ and/or in that a salt which is at least partly soluble in the dispersant and contains Fe is added to the suspension when the slag is to be discharged from the gasification reactor in liquid form.

19. The process according to claim 11, wherein in process step (c) a salt which is at least partly soluble in the dispersant and contains at least one cation selected from the group comprising Ca and Al is added to the suspension when the slag is to be discharged from the gasification reactor in solid form.

20. The process according to claim 11, wherein the solid phosphate precipitates formed in the treatment of the suspension in process step (c) are fed to the gasification reactor together with the suspension.

21. The process according to claim 11, wherein, in a continuous process regime, the suspension is treated in a vessel in process step (c) in such a way that the hydrodynamic residence time T is at least 2 min, preferably at least 5 min, most preferably at least 10 min, the suspension being maintained in the vessel during the residence time by mixing, preferably by stirring.

22. The process according to claim 11, wherein the phosphorus present in the carbon carrier is at least partly in the form of phosphorus compounds that are at least partly soluble in the dispersant.
